(19) United States
(12) Patent Application Publication
(10) Pub. No.: US 2010/0156737 A1
(43) Pub. Date: Jun. 24, 2010

(54) Broadband U-shaped RFID tag antenna with near-isotropic characteristics

(75) Inventors: Ikmo Park, Yongin-si (KR); Sangwoon Lee, Seoul (KR); Hosung Choo, Seoul (KR)

Correspondence Address: THE NATH LAW GROUP, 112 South West Street, Alexandria, VA, 22314, US

(73) Assignee: AJOU UNIVERSITY INDUSTRY COOPERATION FOUNDATION, SUWON-SI (KR)

(21) Appl. No.: 12/588,253

(22) Filed: Oct. 8, 2009

(30) Foreign Application Priority Data
Dec. 18, 2008 (KR) 10-2008-0129586

(51) Int. Cl. H01Q 9/28

(52) U.S. Cl. 343/795

(57) ABSTRACT

A radio frequency identification (RFID) tag antenna in a U shape, having constant near-isotropic characteristics in a broadband. The RFID tag antenna includes a dipole antenna in a U shape, including a plurality of first conducting wires having a first width and separated from and parallel to each other with a first gap and a second conducting wire having a second width and connecting the plurality of first conducting wires; and a feed unit connected to the second conducting wire and located between the plurality of first conducting wires. The RFID tag antenna further includes the dipole antenna in a U shape and the feed unit disposed in the dipole antenna in a U shape, thereby having the constant near-isotropic characteristics in the broadband.

### CROSS-REFERENCE TO RELATED PATENT APPLICATIONS

This application claims the priority of Korean Patent Application No. 10-2008-0129586, filed on Dec. 18, 2008, in the Korean Intellectual Property Office, the disclosure of which is incorporated herein in its entirety by reference.

### BACKGROUND OF THE INVENTION

1. Field of the Invention

The present invention relates to a radio frequency identification (RFID) tag antenna, and more particularly, to an RFID tag antenna including a U-shaped dipole antenna with a feed unit located therein, thereby stably providing a readable range regardless of frequency changes.

2. Description of the Related Art

Recently, according to increase of needs for long range recognition in the field of physical distribution, there is a great interest in an ultrahigh frequency (UHF) band capable of long range recognizing, among several frequencies of radio frequency identification systems. A configuration of such UHF band RFID systems includes a tag attached to an object and a reader system recognizing the tag. The tag receives energy required to drive itself from electromagnetic waves emitted from the reader system. To improve a readable range of UHF band RFID systems, it is required to increase emission power in the reader system. However, since the emission power is restricted by regulations of respective nations, it is unavoidable that a readable range of an RFID system in a restricted emission power is extremely restricted. Therefore, to acquire an optimized readable range, it is required for a tag antenna to have a high radiation efficiency, thereby allowing a long-distance recognition, and it is essential to conjugate match a complex impedance of a tag chip to transfer received maximum power to the tag chip without loss. Also, in a UHF band where a different bandwidth is allocated for each nation, it is required an antenna having broadband characteristics to be easily used in any nation in the world. In addition, it is required a tag antenna capable of well recognizing a tag by a reader system regardless of a direction of the tag and frequency changes because, in the case of tag antennas in a dipole configuration, used as general RFID tag antennas, there is a problem where a recognition range of a reader system is rapidly reduced depending on a direction of a tag due to the null of a radiation pattern.

### SUMMARY OF THE INVENTION

The present invention provides a radio frequency identification tag antenna having constant gain deviation characteristics in a broadband.

According to an aspect of the present invention, there is provided a tag antenna for a radio frequency identification (RFID) system, the tag antenna including: a dipole antenna in a U shape, including a plurality of first conducting wires having a first width and separated from and parallel to each other with a first gap and a second conducting wire having a second width and connected to the plurality of first conducting wires; and a feed unit connected to the second conducting wire and located between the plurality of first conducting wires.

The feed unit may include a plurality of conducting feed wires, each thereof having a third width and separated from each other with a second gap and including one end, orthogonally bent, located opposite to one end of another conducting feed wire and including another end connected to the second conducting wire. A tag chip may be connected between the one ends of the plurality of conducting feed wires. Impedance conjugate matching with the tag chip may be performed by adjusting a length of the plurality of conducting feed wires. The impedance conjugate matching with the tag chip may be performed by adjusting the second gap.

The tag antenna may further include a slit formed on the second conducting wire between the other ends of the plurality of conducting feed wires. The slit may be in a rectangular shape.

There may be a phase difference of 180 degrees between electric currents flowing through the plurality of first conducting wires. The dipole antenna may have a length that is a half of a wavelength of a received signal. The tag antenna may be printed in a single plane structure on a substrate.

The RFID tag antenna according to an embodiment of the present invention may have constant near-isotropic characteristics in a broadband by including the dipole antenna in a U shape and disposing the feed unit in the dipole antenna.

In the RFID tag antenna, the feed unit having a hollow space inside thereof or similar thereto may allow input reactance of the antenna to have inductive elements, thereby performing impedance conjugate matching.

In addition, in the case of the RFID tag antenna, the slit is inserted into the middle of a bottom of the antenna in such a way that a difference between the maximum gain deviation and the minimum gain deviation is reduced, thereby stably providing a readable range regardless of a location and direction of a tag and frequency changes when recognizing the tag by a reader system.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a broadband tag antenna in a U shape according to an embodiment of the present invention;

FIG. 2 illustrates changes in impedance and the return loss characteristics of the tag antenna of FIG. 1, according to a change in a vertical length of the a feed unit shown in FIG. 1;

FIG. 3 illustrates changes in impedance and the return loss characteristics of the tag antenna of FIG. 1, according to a change in a horizontal length of the feed unit shown in FIG. 1;

FIG. 4 illustrates changes in impedance and the return loss characteristics of the tag antenna of FIG. 1, according to a change in a width of a bottom of the tag antenna of FIG. 1;

FIG. 5 illustrates the return loss and gain deviation characteristics of the optimized tag antenna of FIG. 1;

FIG. 6 illustrates a tag antenna according to another embodiment of the present invention;

FIG. 7 illustrates the return loss and gain deviation characteristics of the tag antenna of FIG. 6, according to a change in a length of a slit;

FIG. 8 illustrates the return loss and gain deviation characteristics of the optimized tag antenna of FIG. 6;

FIG. 9 illustrates the radiation efficiency characteristics of the tag antennas of FIGS. 1 and 6;

FIG. 10 illustrates distribution of currents flowing on surfaces of the optimized tag antennas;

FIG. 11 illustrates the recognition characteristics of the optimized tag antenna of FIG. 1, according to a frequency; and

FIG. 12 illustrates results of measuring a maximum readable range of the optimized tag antenna of FIG. 6, according to a direction thereof.

### DETAILED DESCRIPTION OF THE INVENTION

The attached drawings for illustrating preferred embodiments of the present invention are referred to in order to gain a sufficient understanding of the present invention, the merits thereof, and the objectives accomplished by the implementation of the present invention.

Hereinafter, the present invention will be described in detail by explaining preferred embodiments of the invention with reference to the attached drawings. Like reference numerals in the drawings denote like elements.

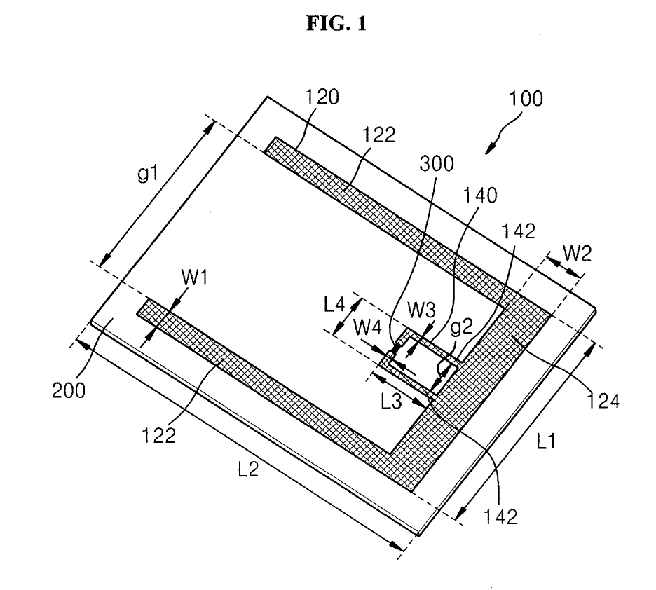

FIG. 1 is a view illustrating a tag antenna 100 according to an embodiment of the present invention. Referring to FIG. 1, the tag antenna 100 may include a dipole antenna body 120 in a U shape and a feed unit 140. Preferably, the tag antenna 100 may be printed in a single plane structure on an RO 4003 substrate 200 having dielectric constant of 3.38 and thickness of 0.2032 mm.

The dipole antenna body 120 in a U shape may be a half of a wavelength (λ/2) of a received signal. Particularly, the dipole antenna body 120 includes a plurality of first conducting wires 122 having a first width W1, separated from each other by a first gap g1, and parallel to each other and a second conducting wire 124 connecting the plurality of first conducting wires 122, thereby having a U shape.

In the case of the dipole antenna body 120 in a U shape, there is a phase difference of 180 degrees between directions of currents flowing along equivalent surfaces of the plurality of first conducting wires 122, thereby compensating a part where a null occurs in a radiation pattern in the case of conventional dipole antennas. Accordingly, a near-point source is formed in the centre of the second conducting wire 124, which is a bottom of the dipole antenna body 120 in a U shape in such a way that electromagnetic waves are uniformly radiated in all directions of 360 degrees from the near-point source, thereby providing a near-isotropic radiation pattern.

Due to such near-isotropic radiation pattern, a radio frequency identification (RFID) system including the tag antenna 100 may have constant recognition ratios regardless of a direction and a location of a tag when receiving information of the tag from a reader since radiation of the tag antenna 100 has near-isotropic characteristics. The near-isotropic radiation pattern of the tag antenna 100 will be described later.

Referring to FIG. 1, the feed unit 140 is connected to the second conducting wire 124. As shown in FIG. 1, the feed unit 140 may include a plurality of conducting feed wires 142, each thereof having a third width W3 and separated from each other by a second gap g2, whose one end orthogonally bent is located opposite to that of another conducting feed wire and another end is connected to the second conducting wire 124. Accordingly, the feed unit 140 may be provided in the shape of a hollow square or similar thereto.

Particularly, the feed unit 140 of the tag antenna 100 is located inside the dipole antenna body 120 in a U shape, that is, located between the plurality of first conducting wires 122.

Also, in the case of the tag antenna 100, to easily perform impedance conjugate matching with a tag chip 300, the feed unit 140 may be in the shape of a hollow square or similar thereto and a tag chip may be connected to the centre of a top of the feed unit 140, that is, connected between the plurality of conducting feed wires 142.

Having such the structure as described above, the feed unit 140 allows an input reactance of an antenna to have inductive elements to compensate capacitive elements of the tag chip 300, thereby performing the impedance conjugate matching. In this case, the tag chip 300 may be a commercial tag chip Higgs of Alien Company and have an input impedance value of about 16-j131Ω at 915 MHz. Also, the size of an antenna may be reduced by locating a feed unit in a dipole antenna body.

Referring to FIG. 1, the tag antenna 100 may have constant gain deviation characteristics in a broadband due to the feed unit 140 inside the dipole antenna body 120 in a U shape. The impedance conjugate matching between the tag antenna 100 and the tag chip 300 may be performed by adjusting one of a length L3 of a first side and a length L4 of a second side of the feed unit 140 or adjusting a width W2 of the bottom of the dipole antenna body 120 in a U shape. This will be described in detail later.

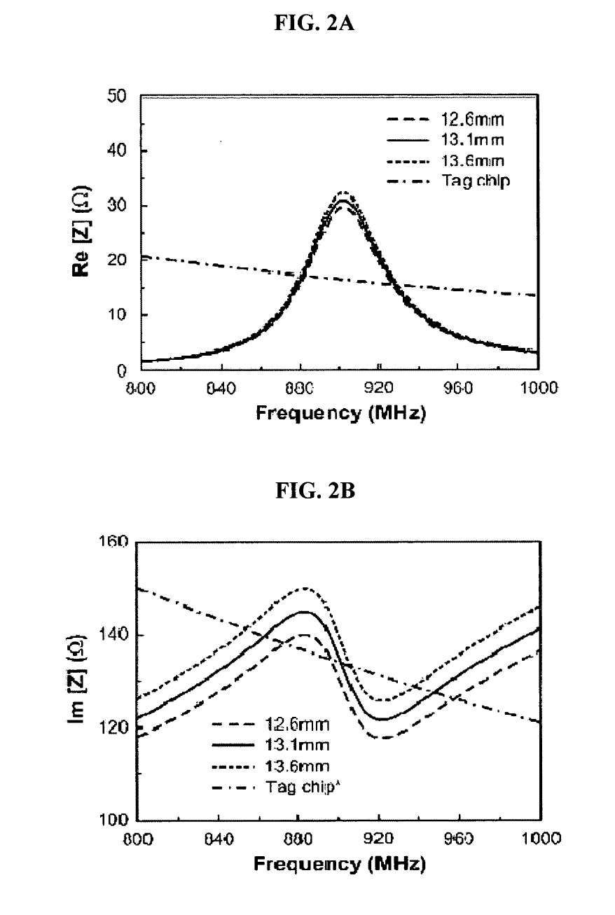

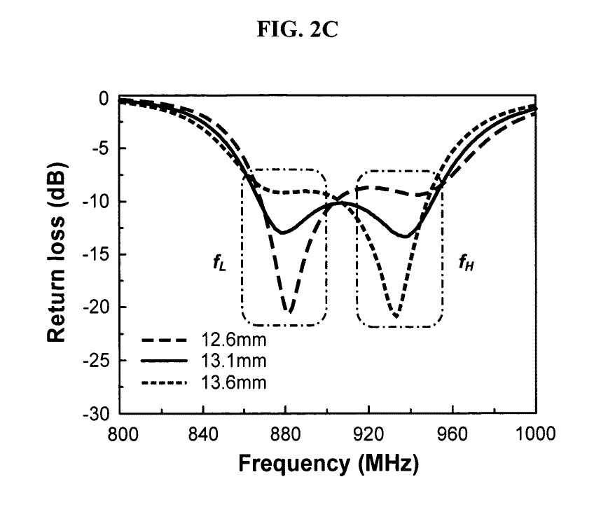

The changes of impedance and return loss characteristics of the tag antenna 100 according to a change in a vertical length of the feed unit 140 in the shape of a square of the tag antenna 100 will be described with reference to FIG. 2. Referring to (a) and (b) in FIG. 2, when increasing the length L3 from 12.6 mm to 13.1 mm and 13.6 mm, it may be known that an input resistance of the tag antenna 100 increases by a very small amount near a centre frequency and an input reactance increases by at regular intervals regardless of a frequency. Also, referring to (c) of FIG. 2, in the case of return loss characteristics of the impedance conjugate matching between an antenna and a tag chip, a low matching frequency fL decreases from 881 MHz to 879 MHz and 878 MHz and a high matching frequency fH decreases from 944 MHz to 937 MHz and 933 MHz. Referring to (c) in FIG. 2, in the case of the change of the return loss characteristics of the tag antenna 100, when the length L3 is 12.6 mm, two parts are matched at a short distance about a frequency where the input reactance of the tag antenna 100 and a complex reactance of the tag chip 300 are a low, thereby forming a low matching frequency. Also, when the length L3 is 13.1 mm, three parts are matched at regular intervals, thereby forming a double matching frequency. When the length L3 is 13.6 mm, two parts are matched at a short distance about a high frequency, thereby forming only a high matching frequency.

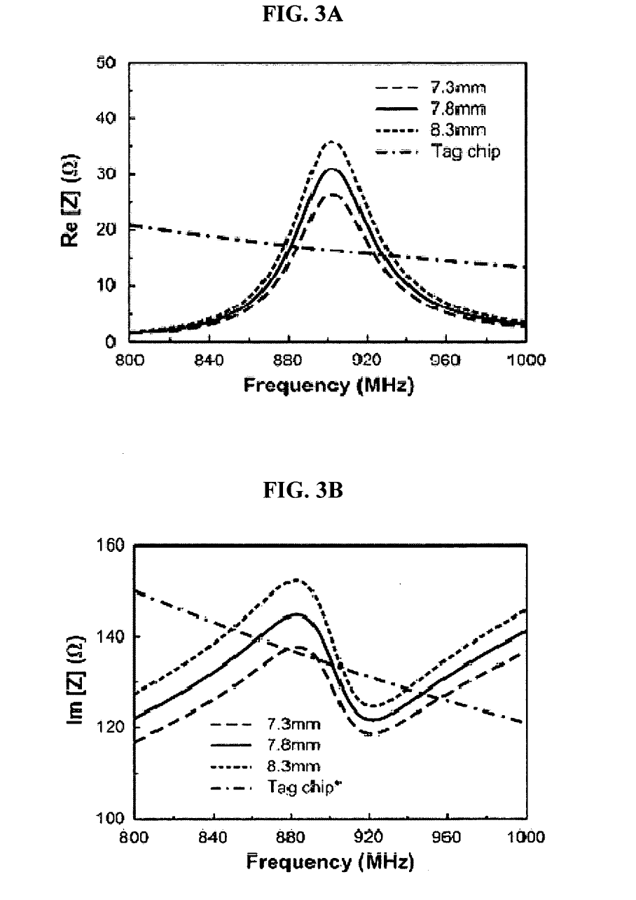

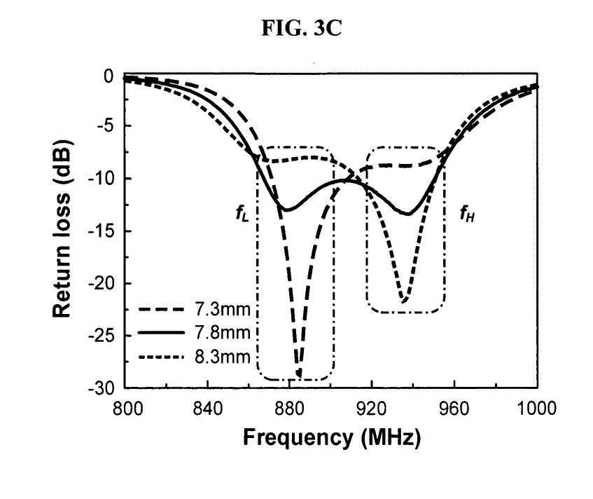

Next, the changes of the impedance and return loss characteristics of the tag antenna 100 with respect to a change in a horizontal length of the feed unit 140 in the shape of a square are illustrated in FIG. 3. Referring to (a) in FIG. 3, when increasing the length L4 from 7.3 mm to 7.8 mm and 8.3 mm, it may be known that an input resistance greatly increases at a centre frequency. Referring to (b) in FIG. 3, an input reactance increases at regular intervals regardless of a frequency. Also, referring to (c) in FIG. 3, in the case of conjugate matched return loss characteristics of the tag antenna and the commercial tag chip, a low matching frequency fL decreases from 885 MHz to 879 MHz and 872 MHz, greater than the change of the vertical length and a high matching frequency fH decreases from 938 MHz to 937 MHz and 935 MHz, smaller than the change of the vertical length.

Such characteristic changes are similar to the change of the vertical length of the feed unit 140. When a horizontal length is 7.3 mm, the input reactance of the antenna greatly changes at a low frequency in such a way that two parts where conjugate matching with the tag chip are matched at a shorter distance, thereby improving only characteristics of a low matching frequency. That is, since having inductive elements due to the feed unit 140 in the shape of a square, the tag antenna 100 is conjugate matched with complex impedance of the tag chip, thereby transferring maximum power received from a reader system to the tag chip.

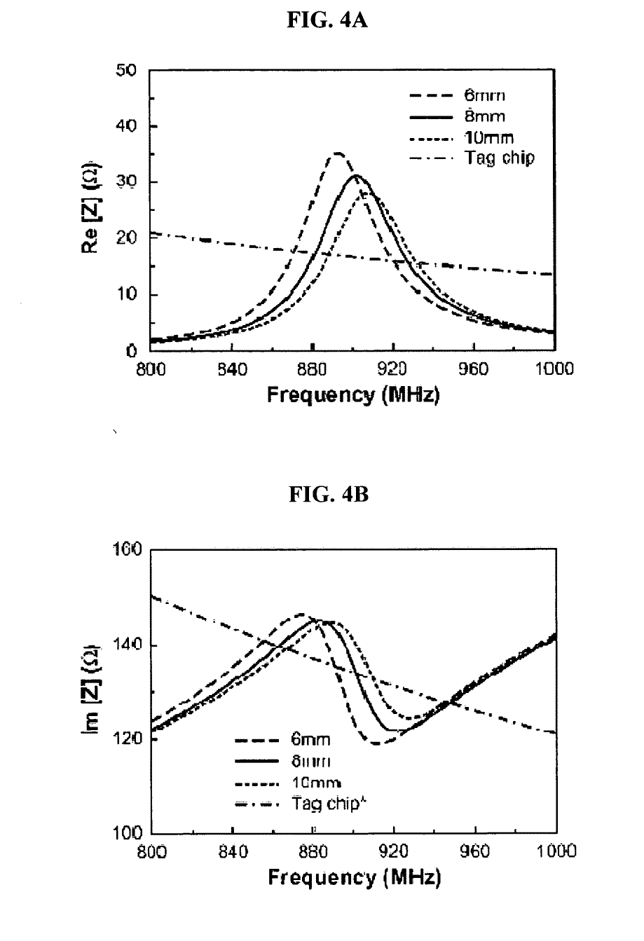

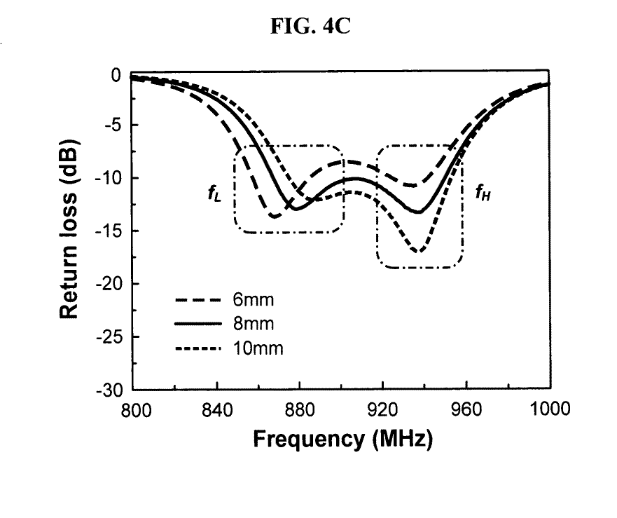

In the above, it has been described that the changes in the impedance and return loss characteristics of the tag antenna 100, according to one of the vertical length and the horizontal length of the feed unit 140. Next, changes in the impedance and return loss characteristics of the tag antenna 100, according to a change in a width W2 of a bottom of the antenna 100 will be described with reference to FIG. 4.

Referring to (a) and (b) of FIG. 4, as increasing the width W2 from 6 mm to 8 mm and 10 mm, an input resistance decreases about a centre frequency and a range of fluctuation of an input reactance greatly decreases. Referring to (c) in FIG. 4, in the case of the return loss characteristics, a low matching frequency fL increases from 868 MHz to 879 MHz and 887 MHz and a high matching frequency fH is almost uniformly maintained as from 935 MHz to 937 MHz and 937 MHz. In such return loss characteristic changes, an input reactance of a high frequency where matching with the tag chip is uniformly maintained but an input reactance of a low frequency increases. Therefore, matching characteristics is improved but a bandwidth of the antenna is reduced. Based on such characteristic changes, design parameters of the optimized tag antenna without a slip are as shown in Table 1. The antenna is optimized by an EM simulator IE3D of Zeland Company.

TABLE 1

| Parameters | Without slit (mm) |
|---|---|
| L1 | 48.0 |
| L2 | 68.0 |
| L3 | 13.1 |
| L4 | 7.8 |
| W1 | 4.0 |
| W2 | 8.0 |
| W3 | 1.0 |
| W4 | 1.0 |
| g1 | 40.0 |
| g2 | 5.8 |

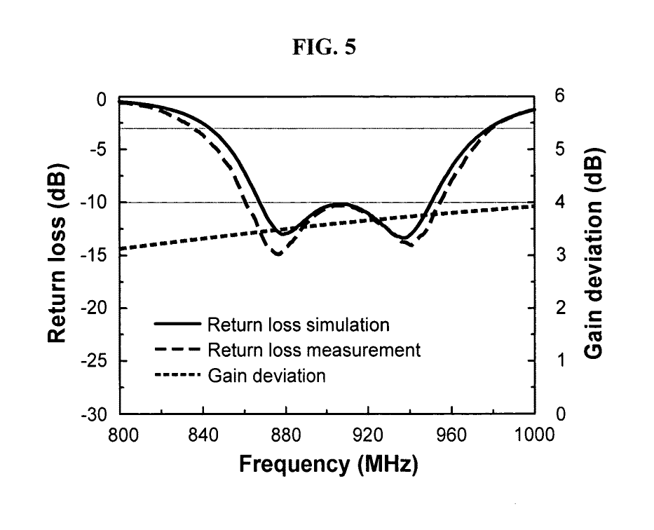

Return loss and gain deviation characteristics of the tag antenna 100 optimized using the design parameters shown in Table 1 are shown in FIG. 5.

Referring to FIGS. 1 and 5 and Table 1, as a result of simulating impedance conjugate matching between the optimized tag antenna and the tag chip, the bandwidth of the antenna is about 9.13% as 867.5 to 950.5 MHz based on voltage standing wave ratio (VSWR)<2, in which the VSWR indicates a degree of impedance matching. A measured bandwidth is about 10.36% as 860.5 to 954.5 MHz. Also, a gain deviation of the tag antenna, which indicates a difference between a maximum gain and a minimum gain in all directions of 360 degrees, is less than 3.77 dB within a corresponding bandwidth.

Also, in a bandwidth based on VSWR<5.8, the bandwidth of the antenna is about 14.83% as 843 to 978 MHz and a measured bandwidth is about 15.78% as 835.5 to 979.5 MHz. Also, a difference between a maximum gain deviation of 3.86 dB and a minimum gain deviation 3.33 dB in the corresponding bandwidth is about 0.53 dB.

According to the result of the simulation as described above, it may be known that the tag antenna 100 has a constant readable range regardless of frequency in a broadband by including the feed unit 140 inside a U shape.

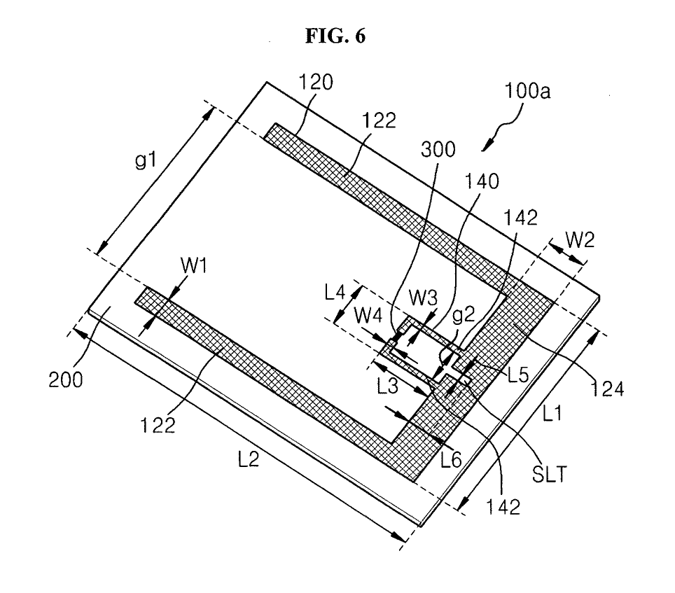

FIG. 6 illustrates a tag antenna 100a according to another embodiment of the present invention.

Referring to FIG. 6, different from the tag antenna 100 of FIG. 1, the tag antenna 100a of FIG. 6 includes a slit SLT on the second conducting wire 124 of the dipole antenna body 120. In this case, the feed unit 140 of the tag antenna 100a may include a plurality of conducting feed wires 142, each thereof located separated from each other by a width L5 of the slit SLT or more, whose one end orthogonally bent is located opposite to that of another conducting feed wire and another end is connected to the second conducting wire 124.

Similar to the tag antenna 100 of FIG. 1, a near-point source is formed in the centre of the bottom of the dipole antenna in a U shape, that is, the second conducting wire 124 and electromagnetic waves are equally radiated all directions of 360 degrees based on the near-point source in such a way that the tag antenna 100a may have a near-isotropic radiation pattern.

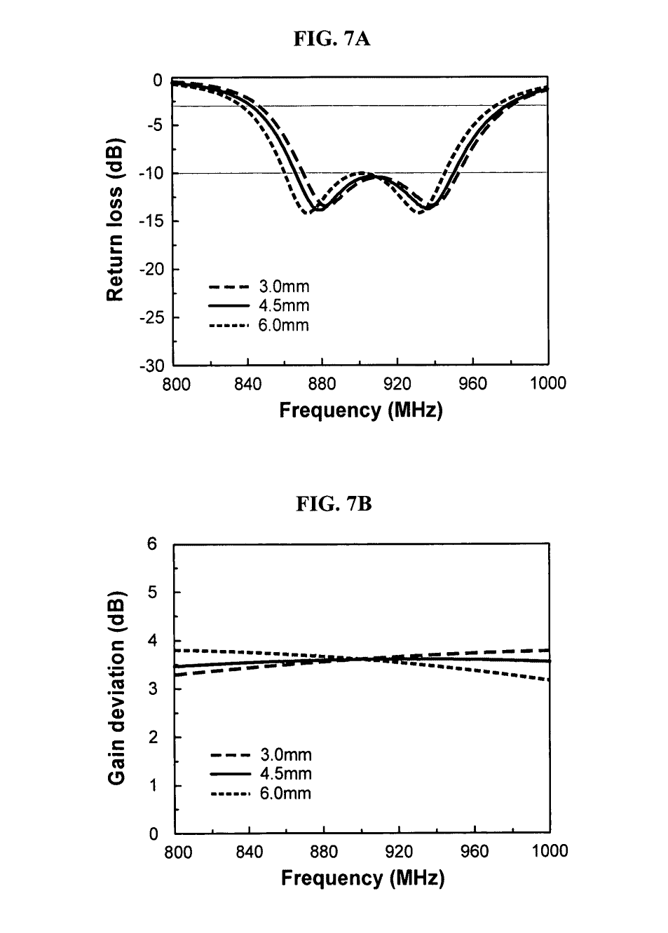

FIG. 7 illustrates return loss and gain deviation characteristics of the tag antenna 100a, according to a change in a length b of the slit SLT. Particularly, in FIG. 7, when the length b of the slit SLT is increased from 3.0 mm to 4.5 mm and 6.0 mm, a double matching frequency is formed by impedance conjugate matching changed input impedance with a tag chip to examine gain deviation characteristics.

Referring to (a) of FIG. 7, in the case of the return loss characteristics, based on VSWR<2, when the slit SLT is 3.0 mm, a frequency has a bandwidth of about 9.00% as 870.5 to 952.5 MHz. When the slit SLT is 4.5 mm, a frequency has a bandwidth about 9.25% as 866 to 950 MHz. Also, when the slit SLT is 6.0 mm, a frequency has a bandwidth of about 9.41% as 860.5 to 945.5 MHz. In the above, though the length of the slit SLT increases, bandwidths are similar. Referring to (b) in FIG. 7, in the case of the gain deviation characteristics, when the length of the slit SLT increases, the gain deviation characteristics increases in a low frequency band but decreases in a high frequency band, thereby forming constant gain deviation characteristics regardless of frequency.

There are shown design parameters with respect to a tag antenna including a slit optimized based on such characteristic changes in Table 2.

TABLE 2

| Parameters | With slit (mm) |
|---|---|
| L1 | 48.0 |
| L2 | 67.5 |
| L3 | 16.1 |
| L4 | 4.8 |
| W1 | 4.0 |
| W2 | 8.0 |
| W3 | 1.0 |
| W4 | 1.0 |
| a | 1.0 |
| b | 4.5 |
| g1 | 40.0 |
| g2 | 2.8 |

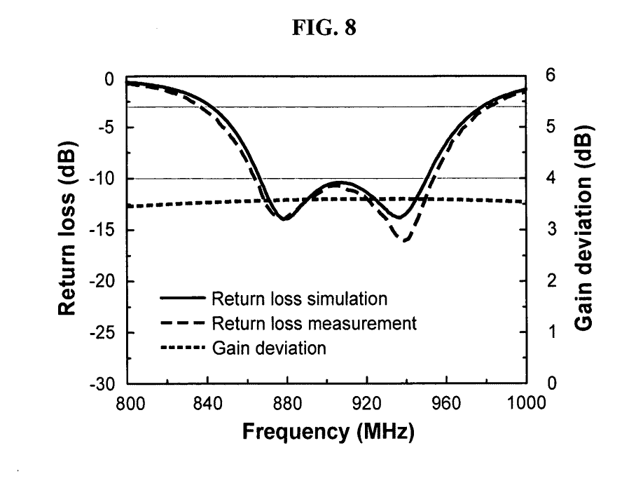

FIG. 8 illustrates return loss and gain deviation characteristics of the tag antenna 100a optimized using the design parameters in Table 2.

Referring to Table 2 and FIGS. 6 to 8, when simulating impedance conjugate matching between an antenna of the tag antenna 100a optimized as described above and a tag chip, a frequency has a bandwidth of about 9.25% as 866 to 950 MHz based on VSWR<2 and has a bandwidth of about 9.84% as 864.5 to 954 MHz as a result of measuring. It may be known that a gain deviation is less than 3.60 dB in a corresponding bandwidth. Also, in a bandwidth based on VSWR<5.8, a frequency has a bandwidth of about 15.89% as 837 to 981.5 MHz. In this case, in a corresponding bandwidth, a maximum gain deviation is 3.60 dB and a minimum gain deviation is 3.54 dB. A difference between the maximum gain deviation and the minimum gain deviation is about 0.06 dB, which is almost uniform.

According to the result of simulating as described above, the tag antenna 100a includes the feed unit 140 inside a U shape and the slit SLT on the second conducting wire 124, thereby having a more constant readable range in a broadband. Since other elements and operations of the tag antenna 100a of FIG. 6 are similar to that of the tag antenna 100 of FIG. 1, detailed description thereof will be omitted.

As described above, since accepting a UHF bandwidth 860 to 960 MHz of an RFID system required in the whole world, both of the tag antenna 100 without a slit and the tag antenna 100a including the slit SLT may be use as a single RFID tag antenna. When a reader system reads a tag, the tag antenna 100a including the slit SLT has a more constant readable range since regardless of a change in a frequency.

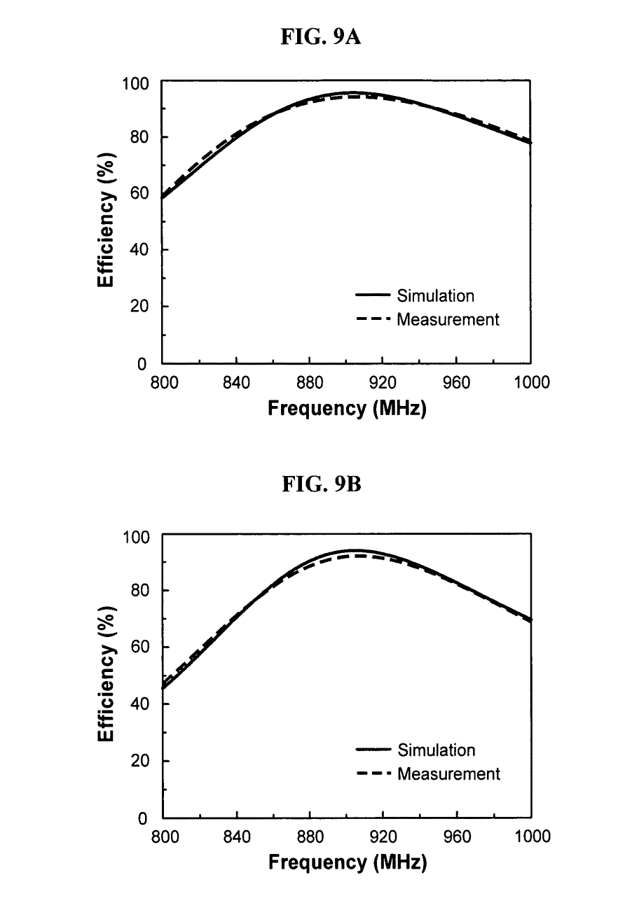

FIG. 9 illustrates radiation efficiency characteristics of the tag antennas 100 and 100a. In FIG. 9, the radiation efficiency characteristics were measured using Wheeler Cap method using an input resistance measured in a free space and an input resistance measured after shielding by a conductor to prevent an antenna from radiating. Results of simulating and measuring according to respective structures are shown in a solid line and a dotted line. It may be known that the two results are very similar to each other.

Referring to (a) in FIG. 9, the results of simulating and measuring the tag antenna 100 optimized as Table 1 in a bandwidth of VSWR<2 are shown as radiation efficiencies of 89.8% or more and 88.4% or more, respectively. Also, in a bandwidth of VSWR<5.8, the results of simulating and measuring are shown as radiation efficiencies of 81.1% or more and 79.4% or more, respectively.

Referring to (b) of FIG. 9, the results of simulating and measuring the tag antenna 100a including the slit SLT and optimized as Table 2 in a bandwidth of VSWR<2 are shown as radiation efficiencies of 85.1% or more and 84.0% or more, respectively. Also, in a bandwidth of VSWR<5.8, the results of simulating and measuring are shown as radiation efficiencies of 72.5% or more and 72.9% or more, respectively, which are relatively high.

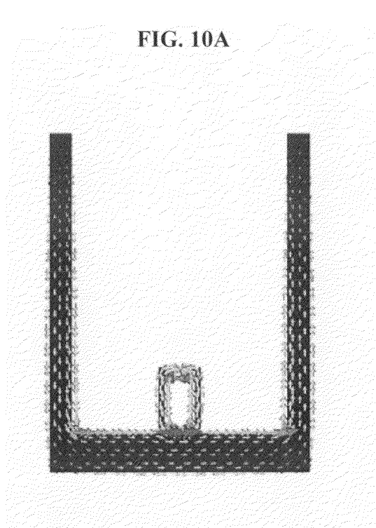

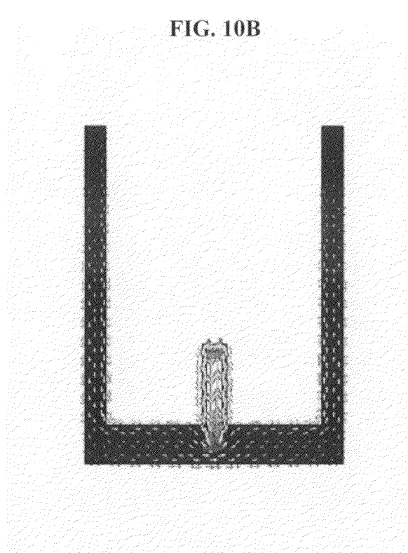

FIG. 10 illustrates distribution of currents flowing on surfaces of the optimized tag antennas.

Referring to FIG. 10, both of (a) illustrating a case of the tag antenna 100 without a slit and (b) illustrating a case of the tag antenna with the slit SLT have currents having the same strength and flowing through both ends of the dipole antenna body 120 in a U shape and a phase difference thereof is 180°, thereby compensated a part of a radiation pattern, in which a null occurs, at a far-field. Also, currents vertically flowing through both ends of the feed unit 140, which, have the same strength and a phase difference of 180°, thereby compensated at a far-field. However, in the case of currents flowing through a top and a bottom of the feed unit 140 parallel to each other, whose direction are opposite to each other, since the current flowing the bottom of the feed unit 140 is vastly stronger than the current flowing through the top thereof, there is formed a near-point source in a bottom of the dipole antenna body 120 and electromagnetic waves are uniformly radiated, thereby forming a radiation pattern close to isotropy.

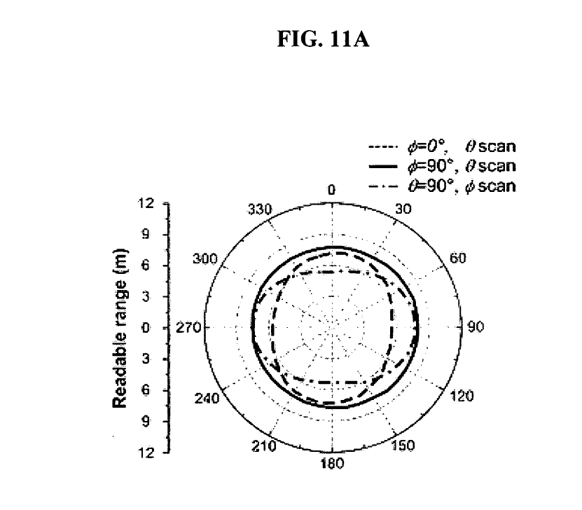

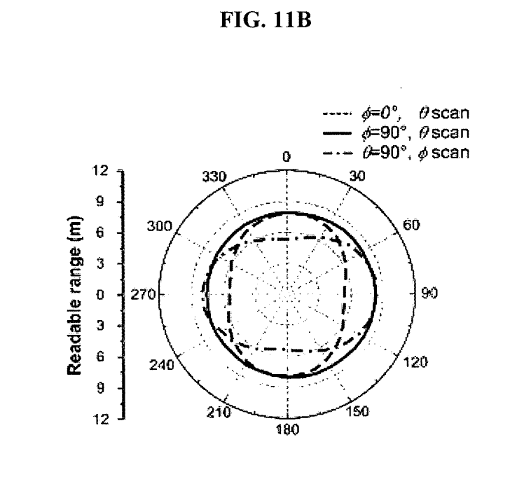

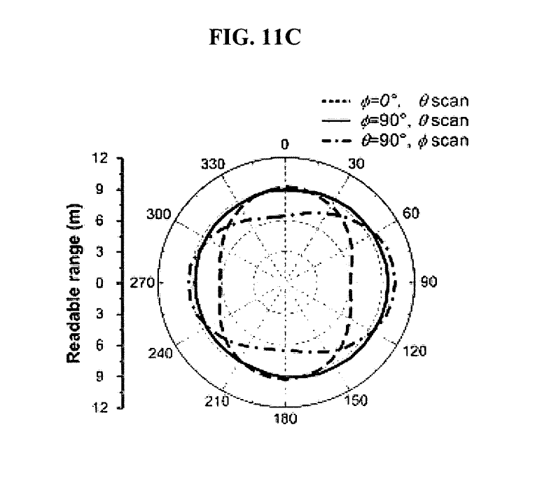

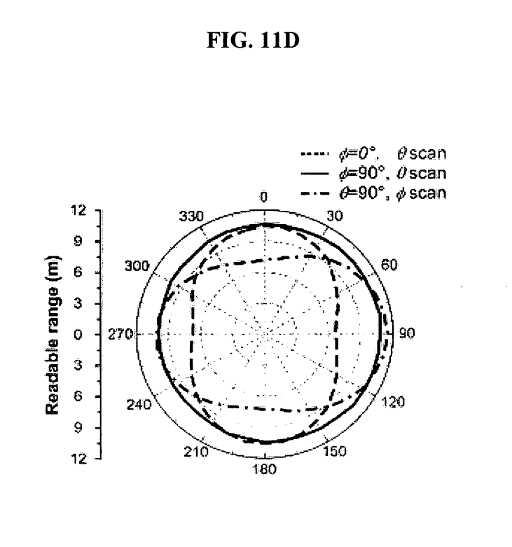

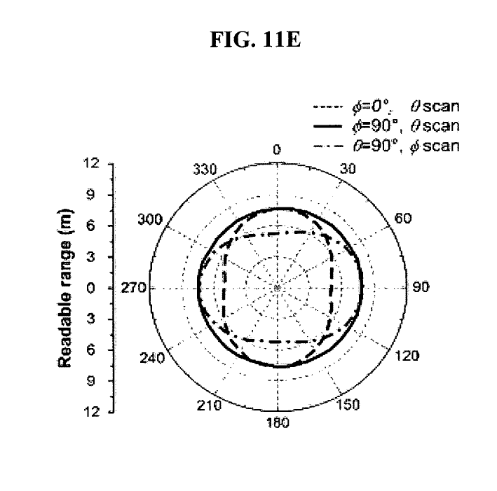

FIG. 11 illustrates recognition characteristics of the optimized tag antenna 100 of FIG. 1, which does not include a slit and is optimized as shown in Table 1, according to a frequency. A readable range of the tag antenna 100 is a maximum readable range according to a direction of the tag antenna 100, measured using a circular polarized reader antenna in a radio anechoic chamber.

Referring to FIG. 11, readable ranges were measured as 8.04 to 5.29 m at 870 MHz, 8.38 to 5.30 m at 890 MHz, 10.23 to 6.10 m at 910 MHz, 11.48 to 6.69 m at 930 MHz, and 7.95 to 5.01 m at 950 MHz. As shown in FIG. 11, the tag antenna 100 has relatively constant readable ranges in an operation frequency when a reader system reads a tag.

A result of measuring readable ranges according to frequency with respect to the tag antenna 100 is summarized in Table 3.

TABLE 3
(unit: m)

| | Φ = 0° | | Φ = 90° | | θ = 90° | |
|---|---|---|---|---|---|---|
| | Maxi- | Mini- | Maxi- | Mini- | Maxi- | Mini- |
| | mum | mum | mum | mum | mum | mum |
| 870 MHz | 7.31 | 5.56 | 8.04 | 7.51 | 7.69 | 5.29 |
| 890 MHz | 7.92 | 5.35 | 8.29 | 7.55 | 8.38 | 5.30 |
| 910 MHz | 9.34 | 6.10 | 9.56 | 8.52 | 10.23 | 6.40 |
| 930 MHz | 10.60 | 6.69 | 10.96 | 9.89 | 11.48 | 7.09 |
| 950 MHz | 7.68 | 5.01 | 7.93 | 7.32 | 7.95 | 5.20 |

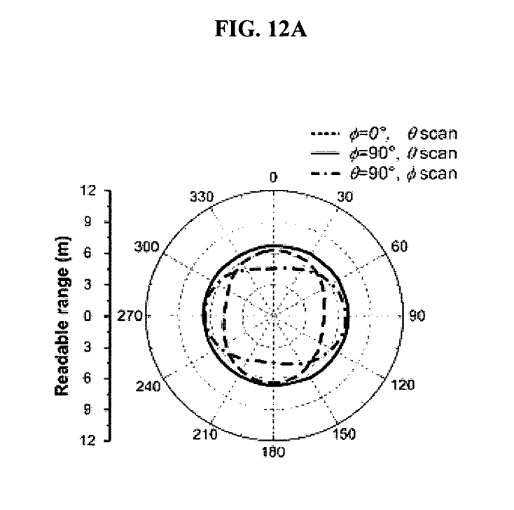

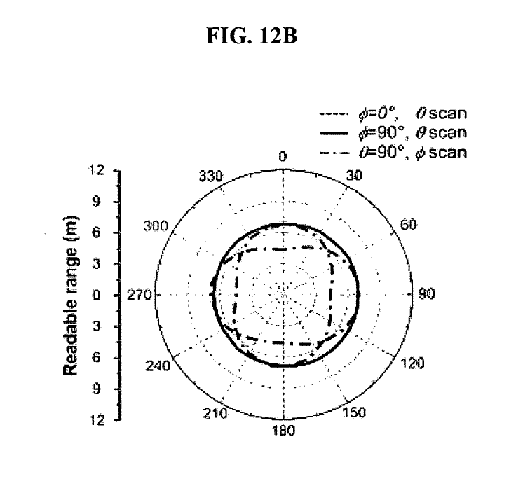

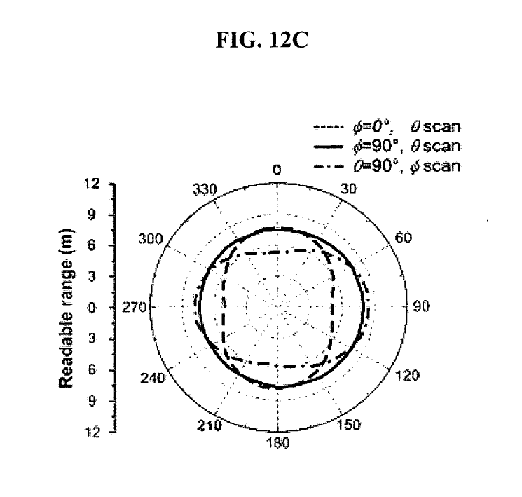

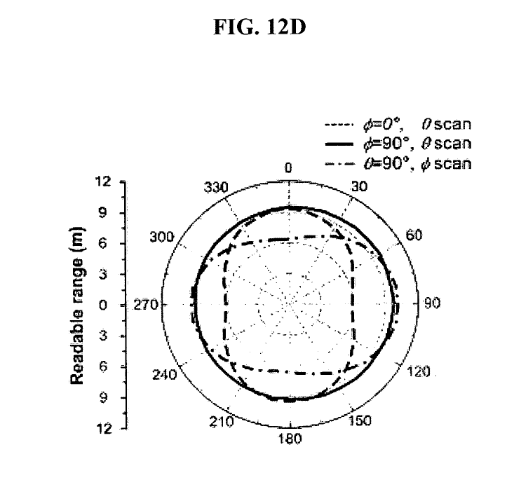

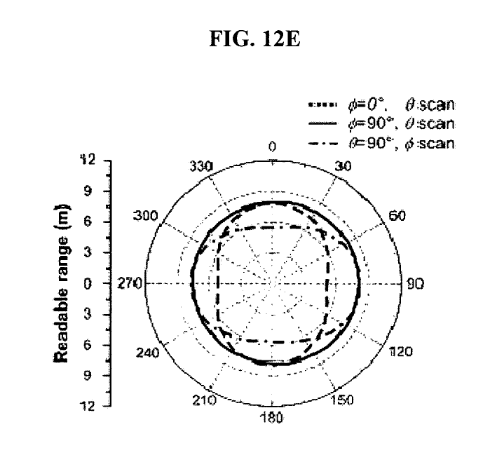

FIG. 12 illustrates results of measuring a maximum readable range of the optimized tag antenna 100a of FIG. 6, including the slit SLT and optimized as shown in Table 2, according to a direction of the tag antenna 100a Referring to FIG. 12, readable ranges are measured as 6.93 to 4.48 m at 870 MHz, 7.05 to 4.34 m at 890 MHz, 8.42 to 5.01 m at 910 MHz, 10.11 to 5.89 m at 930 MHz, and 8.22 to 5.13 m at 950 MHz. Similar to the tag antenna 100 of FIG. 1, in the case of the tag antenna 100a, it may be known that an RFID tag antenna in a U shape, having constant near-isotropic characteristics in a provided broadband has a stable readable range regardless of a change in frequency in an operation bandwidth when a reader system reads a tag.

That is, a result of measuring readable ranges according frequency with respect to the tag antenna 100a of FIG. 6 is summarized in Table 4.

TABLE 4
(unit: m)

| | Φ = 0° | | Φ = 90° | | θ = 90° | |
|---|---|---|---|---|---|---|
| | Maxi- | Mini- | Maxi- | Mini- | Maxi- | Mini- |
| | mum | mum | mum | mum | mum | mum |
| 870 MHz | 6.47 | 4.64 | 6.93 | 6.61 | 6.77 | 4.48 |
| 890 MHz | 6.90 | 4.39 | 7.05 | 6.58 | 6.98 | 4.34 |
| 910 MHz | 7.87 | 5.01 | 7.95 | 7.33 | 8.42 | 5.31 |
| 930 MHz | 9.45 | 5.89 | 9.78 | 8.91 | 10.11 | 6.38 |
| 950 MHz | 7.95 | 5.13 | 8.12 | 7.57 | 8.22 | 5.43 |

As described above, the RFID tag antennas according to the embodiments of the present invention have characteristics as follows.

Both of the tag antenna 100 without a slit and the tag antenna 100a including the slit SLT obtain broadband characteristics satisfying a UHF bandwidth by conjugate matching with a commercial tag chip. In the case of the tag antenna 100 without a slit, a difference between a maximum gain deviation and a minimum gain deviation in an operation bandwidth was about 0.53 dB and readable ranges were measured as 8.04 to 5.29 m at 870 MHz, 8.38 to 5.30 m at 890 MHz, 10.23 to 6.10 m at 910 MHz, 11.48 to 6.69 m at 930 MHz, and 7.95 to 5.01 m at 950 MHz. In the case of the tag antenna 100a including the slit SLT on the dipole antenna body 120, a difference between a maximum gain deviation and a minimum gain deviation in an operation bandwidth was about 0.06 dB, which is very uniform, and readable ranges were measured as 6.93 to 4.48 m at 870 MHz, 7.05 to 4.34 m at 890 MHz, 8.42 to 5.01 m at 910 MHz, 10.11 to 5.89 m at 930 MHz, and 8.22 to 5.13 m at 950 MHz, which were stable. Accordingly, since the tag antennas according to the embodiments of the present invention have constant near-isotropic characteristics in 860 to 960 MHz, which is a UHF bandwidth of an RFID system, thereby used as an RFID tag available in all countries.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A tag antenna for a radio frequency identification (RFID) system, the tag antenna comprising:
a dipole antenna in a U shape, comprising a plurality of first conducting wires having a first width and separated from and parallel to each other with a first gap and a second conducting wire having a second width and connected to the plurality of first conducting wires; and
a feed unit connected to the second conducting wire and located between the plurality of first conducting wires.

2. The tag antenna of claim 1, wherein the feed unit comprises a plurality of conducting feed wires, each thereof having a third width and separated from each other with a second gap and including one end, orthogonally bent, located opposite to one end of another conducting feed wire and including another end connected to the second conducting wire.

3. The tag antenna of claim 2, wherein a tag chip is connected between the one ends of the plurality of conducting feed wires, and
wherein the feed unit is in a hollow-square shape formed by the plurality of conducting feed wires connected to the tag chip.

4. The tag antenna of claim 3, wherein impedance conjugate matching with the tag chip is performed by adjusting a length of the plurality of conducting feed wires.

5. The tag antenna of claim 3, wherein impedance conjugate matching with the tag chip is performed by adjusting the second gap.

6. The tag antenna of claim 2, further comprising a slit formed on the second conducting wire between the other ends of the plurality of conducting feed wires.

7. The tag antenna of claim 6, wherein the slit is in a rectangular shape.

8. The tag antenna of claim 1, wherein there is a phase difference of 180 degrees between electric currents flowing through the plurality of first conducting wires.

9. The tag antenna of claim 1, wherein the dipole antenna has a length that is a half of a wavelength of a received signal.

10. The tag antenna of claim 1, wherein the tag antenna is printed in a single plane structure on a substrate.

11. A tag comprising the tag antenna of claim 1.

12. A tag antenna of an RFID system, the tag antenna comprising:
a dipole body, in a U shape, comprising a plurality of first conducting wires having a first width and separated from and parallel to each other with a first gap and a second conducting wire having a second width and connected to the plurality of first conducting wires;
a feed unit connected to the second conducting wire and located between the plurality of first conducting wires; and
a slit formed on the second conducting wire.

13. The tag antenna of claim 12, wherein the feed unit comprises a plurality of conducting feed wires, each thereof having a third width and separated from the slit and including one end, orthogonally bent, located opposite to one end of another conducting feed wire and including another end connected to the second conducting wire.

14. The tag antenna of claim 13, wherein a tag chip is connected between the one ends of the plurality of conducting feed wires, and
wherein the feed unit is in a hollow-square shape formed by the plurality of conducting feed wires connected to the tag chip.

15. The tag antenna of claim 12, wherein the slit is in a rectangular shape.
